(19) United States
(12) Patent Application Publication
(10) Pub. No.: US 2026/0350925 A1
(43) Pub. Date: Nov. 5, 2026

(54) PRESENTATION OF THREE-DIMENSIONAL OBJECT IN INTERFACE

(71) Applicant: Beijing Zitiao Network Technology Co., Ltd., Beijing (CN)

(72) Inventors: Xinyi Zhou, Beijing (CN); Zhenwei Lai, Beijing (CN); Fujia Wang, Beijing (CN); Jianfei Chang, Beijing (CN)

(21) Appl. No.: 19/664,942

(22) Filed: Apr. 30, 2026

(30) Foreign Application Priority Data
Apr. 30, 2025 (CN) 2025105729815

(51) Int. Cl. G06T 19/00; G06T 13/20

(52) U.S. Cl. CPC G06T 19/00; G06T 13/20; G06T 2200/24; G06T 2219/024

(57) ABSTRACT

A method, an apparatus, a device, a medium, and a product for presenting a three-dimensional object in an interface are provided. The method includes: adding, in response to receiving a presentation request to present the three-dimensional object in the interface, a three-dimensional rendering layer to the interface, the three-dimensional rendering layer corresponding to a three-dimensional space; generating, in the three-dimensional space, a three-dimensional visual element corresponding to a two-dimensional visual element in the interface, a three-dimensional position of the three-dimensional visual element in the three-dimensional space corresponding to a two-dimensional position of the two-dimensional visual element in the interface; adding the three-dimensional object specified by the presentation request to the three-dimensional space; and projecting the three-dimensional visual element and the three-dimensional object to the three-dimensional rendering layer.

### CROSS-REFERENCE

This application claims priority to Chinese Patent Application No. 2025105729815, filed on Apr. 30, 2025, and entitled “METHOD, APPARATUS, DEVICE, MEDIUM AND PRODUCT FOR PRESENTING THREE-DIMENSIONAL OBJECT IN INTERFACE”, which is incorporated herein by reference in its entirety.

### FIELD

Example embodiments of the present disclosure generally relate to the field of computers, and in particular, to presentation of a three-dimensional object in an interface.

### BACKGROUND

With the development of computer technologies, various live streaming can provide people with information in many aspects such as news, education, and entertainment. In the process of live streaming, users watching the live streaming may perform various interactive behaviors in the live streaming room. Some interactive behaviors may trigger presentation of specific visual elements and objects in the live streaming interface. It is desired to enrich presentation manners of visual elements and objects in the live streaming interface.

### SUMMARY

In a first aspect of the present disclosure, a method for presenting a three-dimensional object in an interface is provided. The method includes: adding, in response to receiving a presentation request to present the three-dimensional object in the interface, a three-dimensional rendering layer to the interface, the three-dimensional rendering layer corresponding to a three-dimensional space; generating, in the three-dimensional space, a three-dimensional visual element corresponding to a two-dimensional visual element in the interface, a three-dimensional position of the three-dimensional visual element in the three-dimensional space corresponding to a two-dimensional position of the two-dimensional visual element in the interface; adding the three-dimensional object specified by the presentation request to the three-dimensional space; and projecting the three-dimensional visual element and the three-dimensional object to the three-dimensional rendering layer.

In a second aspect of the present disclosure, an apparatus for presenting a three-dimensional object in an interface is provided. The apparatus includes: a receiving module configured to add, in response to receiving a presentation request to present the three-dimensional object in the interface, a three-dimensional rendering layer to the interface, the three-dimensional rendering layer corresponding to a three-dimensional space; a generation module configured to generate, in the three-dimensional space, a three-dimensional visual element corresponding to a two-dimensional visual element in the interface, a three-dimensional position of the three-dimensional visual element in the three-dimensional space corresponding to a two-dimensional position of the two-dimensional visual element in the interface; an addition module configured to add the three-dimensional object specified by the presentation request to the three-dimensional space; and a presentation module configured to project the three-dimensional visual element and the three-dimensional object to the three-dimensional rendering layer.

In a third aspect of the present disclosure, an electronic device is provided. The device includes at least one processor; and at least one memory, the at least one memory being coupled to the at least one processor and storing instructions executable by the at least one processor, the instructions, when executed by the at least one processor, causing the electronic device to perform the method of the first aspect.

In a fourth aspect of the present disclosure, a computer-readable storage medium is provided. The medium has computer instructions stored thereon, the computer instructions, when executed by a processor, implementing the method of the first aspect.

In a fifth aspect of the present disclosure, a computer program product is provided. The product includes a computer program, the computer program, when executed by a processor, implementing the method of the first aspect.

It should be appreciated that the content described in this Summary section is neither intended to identify key or essential features of the embodiments of the present disclosure, nor is it intended to limit the scope of the present disclosure. Other features of the present disclosure will be readily envisaged through the following description.

### BRIEF DESCRIPTION OF THE DRAWINGS

The above and other features, advantages and aspects of the embodiments of the present disclosure will become more apparent in combination with the drawings and with reference to the following detailed description. In the drawings, the same or similar reference numerals represent the same or similar elements, where:

FIG. 1 shows a schematic diagram of an example environment in which the embodiments of the present disclosure can be implemented;

FIG. 2 shows an example of a live streaming interface of a live streaming application;

FIG. 3 shows an example of an interface according to some embodiments of the present disclosure;

FIG. 4 shows an example of presenting a three-dimensional object according to some embodiments of the present disclosure;

FIGS. 5A to 5C show example interfaces according to some embodiments of the present disclosure;

FIG. 6 shows a flowchart of a method for presenting a three-dimensional object in an interface according to some embodiments of the present disclosure;

FIG. 7 shows a schematic structural block diagram of an apparatus for presenting a three-dimensional object in an interface according to some embodiments of the present disclosure; and

FIG. 8 shows a block diagram of an electronic device in which one or more embodiments of the present disclosure may be implemented.

### DETAILED DESCRIPTION

The embodiments of the present disclosure will be described in more detail below with reference to the drawings. Although some embodiments of the present disclosure are shown in the drawings, it should be understood that the present disclosure may be implemented in various forms and should not be construed as being limited to the embodiments set forth herein. Instead, these embodiments are provided for a more thorough and complete understanding of the present disclosure. It should be understood that the drawings and embodiments of the present disclosure are only used for illustrative purposes, and are not used to limit the protection scope of the present disclosure.

In the description of the embodiments of the present disclosure, the term "include/comprise" and similar terms should be understood as open-ended inclusions, that is, "include/comprise but not limited to". The term "based on" should be understood as "at least partially based on". The term "an embodiment" or "the embodiment" should be understood as "at least one embodiment". The term "some embodiments" should be understood as "at least some embodiments". Other definitions, both explicit and implicit, may also be included below.

In this article, unless explicitly stated, the execution of a step "in response to A" does not mean that the step is executed immediately after "A", but may include one or more intermediate steps.

It may be understood that the data involved in the technical solution (including but not limited to the data itself, acquisition, use, storage or deletion of the data) should comply with the requirements of corresponding laws, regulations and related provisions.

It may be understood that before using the technical solutions disclosed in the embodiments of the present disclosure, the relevant users should be informed of the type, range of use, use scenarios, etc. of the information involved in the present disclosure and obtain the authorization of the relevant users in an appropriate manner in accordance with relevant laws and regulations, where the relevant users may include any type of subject of rights, such as individuals, enterprises, and groups.

For example, in response to receiving an active request from the user, prompt information is sent to the relevant user to clearly prompt the relevant user that the requested operation will require access to and use of the information of the relevant user, so that the relevant user may independently choose, based on the prompt information, whether to provide the information to the software or hardware, such as the electronic device, the application, the server, or the storage medium, that performs the operations of the technical solutions of the present disclosure.

As an optional but non-limiting implementation, in response to receiving the active request from the relevant user, the prompt information may be sent to the relevant user in the form of, for example, a pop-up window, in which the prompt information may be presented in text. Furthermore, the pop-up window may also include a selection control for the user to choose whether to "agree" or "disagree" to provide the information to the electronic device.

It may be understood that the above process of notifying and obtaining user authorization is only illustrative, and does not limit the implementations of the present disclosure. Other manners that satisfy the relevant laws and regulations may also be applied in the implementations of the present disclosure.

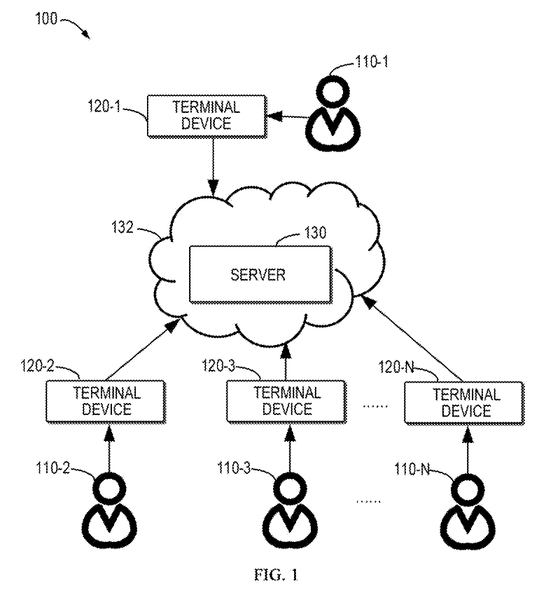

FIG. 1 shows a schematic diagram of an example environment 100 in which the embodiments of the present disclosure may be implemented. In the environment 100, one or more users 110-1, 110-2, 110-3, ..., 110-N may watch a live streaming (sometimes also referred to as a "live streaming session") and participate in live streaming interactive events through their associated terminal devices 120-1, 120-2, ..., 120-N, respectively. For the convenience of discussion, the users 110-1, 110-2, ..., 110-N may be collectively or individually referred to as a user 110, and the terminal devices 120-1, 120-2, ..., 120-N may be collectively or individually referred to as a terminal device 120.

In some embodiments, among all the users 110, one or more users (for example, the user 110-1) may initiate a live streaming through the associated terminal device 120-1. In some scenarios, the user 110-1 who initiates the live streaming may also be referred to as a streamer, a streamer user, a streaming party, or a streaming management party of the live streaming session. In some embodiments, all the users 110 may also include at least one live streaming participant participating in the live streaming. A user identifier of the live streaming participant may be presented in the live streaming interface, and the live streaming participant may interact with the streamer in the live streaming. The user identifier may include any appropriate information such as a user avatar, a username, a user ID, etc. Herein, the at least one live streaming participant (for example, a guest, etc.) may also be referred to as at least one invited user. In some embodiments, all the users 110 may also include a viewing user watching the live streaming, and the viewing user may perform interactive behaviors such as commenting and giving likes on the live streaming.

In some embodiments, the terminal devices 120 may be respectively installed with applications capable of providing live streaming services, or may access websites capable of providing live streaming services. The user 110 may operate the terminal device 120 to access a corresponding application or website. Correspondingly, the terminal device 120 may present a corresponding live streaming interface, which for example, may provide live streaming content, such as audio live streaming content or video live streaming content, of a live streaming room. The application installed on the terminal device 120 may be any appropriate application such as a live streaming application, a shopping application, and a content sharing application (for example, a video application mainly for sharing videos, or other applications for sharing content such as audio and images). The interface provided by the application may include at least a live streaming interface of the live streaming.

In some embodiments, the terminal device 120 may also communicate with a server 130 through a network 132 to implement the provision of live streaming services. The server 130 may provide functions such as management, configuration, and maintenance of the application or website. In some embodiments, the server 130 may store data generated during the live streaming, including live streaming interaction data generated in the live streaming interaction.

The terminal device 120 may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a television receiver, a radio broadcast receiver, an e-book device, a game device, or any combination of the foregoing, including the accessories and peripherals of these devices or any combination thereof. In some embodiments, the terminal device 120 may also support any type of user-specific interface (such as a "wearable" circuit, etc.).

The server 130 may be an independent physical server, a server cluster or distributed system composed of multiple physical servers, or a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The server 130 may include, for example, a computing system/server, such as a mainframe, an edge computing node, a computing device in a cloud environment, and so on. The server 130 may provide background services for applications supporting live streaming in the terminal device 120. It should be understood that the structures and functions of the elements in the environment 100 are described for illustrative purposes only, without suggesting any limitation on the scope of the present disclosure.

As mentioned above, some interactive behaviors may trigger the presentation of specific visual elements in the live streaming interface. Traditionally, a terminal device may only present visual elements in a two-dimensional format, and the visual elements are usually presented by the terminal device in a fixed manner (for example, a fixed path). This may affect the visual experience of the user watching the live streaming and interacting in the live streaming.

In view of this, embodiments of the present disclosure provide an improved solution for presenting a three-dimensional object in an interface. According to this solution, in response to receiving a presentation request to present the three-dimensional object in the interface, a three-dimensional rendering layer is added to the interface, where the three-dimensional rendering layer corresponds to a three-dimensional space. In the three-dimensional space, a three-dimensional visual element corresponding to a two-dimensional visual element in the interface is generated, where a three-dimensional position of the three-dimensional visual element in the three-dimensional space corresponds to a two-dimensional position of the two-dimensional visual element in the interface. The three-dimensional object specified by the presentation request is added to the three-dimensional space. The three-dimensional visual element and the three-dimensional object are projected to the three-dimensional rendering layer.

In this way, a three-dimensional effect may be displayed on a two-dimensional screen, the content of the live streaming interface can be enriched, the visual experience of the live streaming interface can be enriched, and the visual experience of the user watching the live streaming and interacting in the live streaming can be improved.

In the present disclosure, "triggering" refers to one or more interactive operations of the user on the terminal device. Furthermore, these interactive operations may be triggered in the same user interface/pop-up window, or may be triggered in different user interfaces/pop-up windows. The present disclosure is not limited in this regard. In the present disclosure, in the interface, a three-dimensional object may be used to represent a virtual resource, which sometimes may also be referred to as an incentive. This refers to a resource or incentive that the streamer user and at least one invited user can obtain in the live streaming. Examples of the virtual resource may include, but are not limited to: a physical or virtual object (for example, a gift, etc.), a coupon, a point-based incentive, etc. The virtual resource in the live streaming is usually configurable. The present disclosure does not limit the specific virtual resource. The terminal device 120 may obtain an interactive resource of a corresponding type in response to the triggering of an acquisition control. In the context of the present disclosure, the process of giving the virtual resource to the streamer and/or the invited user may be presented with a three-dimensional visual effect.

Some example embodiments of the present disclosure will be further described below with reference to the drawings. The method for presenting a three-dimensional object in an interface according to the present disclosure may be implemented in the terminal device 120. It should be noted that the operations performed by the terminal device 120 may be specifically performed by a relevant application installed on the terminal device 120. Some operations described with reference to the terminal device 120 may require the assistance of the server 130 to be completed.

It should be understood that the interfaces shown in the drawings are only examples, and there may actually be various interface designs. Each graphic element in the interface may have different arrangements and different visual representations, one or more of the elements may be omitted or replaced, and there may also be one or more other elements. The embodiments of the present disclosure are not limited in this regard.

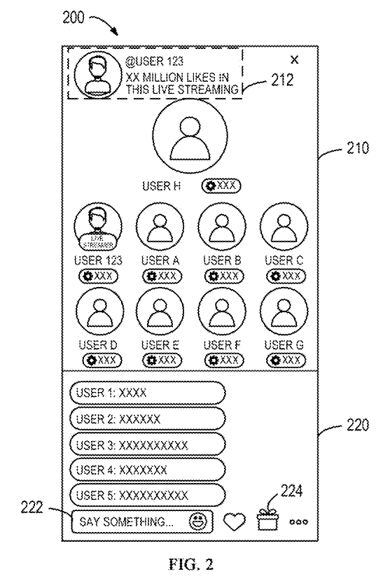

Reference is made to FIG. 2, which shows an example interface 200 of a live streaming interface of a live streaming application. The example interface 200 may include an area 210 and an area 220. The area 210 may include an area 212 for presenting information of a streamer user (for example, User 123). The information of the streamer user may include, for example, an avatar of the streamer user, a name of the streamer user, a number of likes given to the live streaming, a title of the live streaming, and so on. In the case that the live streaming includes a streamer user and at least one invited user, the area 210 may present respective user identifiers of the streamer user and the at least one invited user (for example, User A to User H shown in the figure). The user identifiers may include, for example, user avatars and usernames. The terminal device 120 may also present points obtained by the corresponding users in the live streaming (for example, "XXX" in the figure) in association with each user identifier. The points may be associated with the number of virtual resources obtained by the users, the number of likes received, the interaction duration, etc.

It may be understood that the plurality of user identifiers may be presented in the area 210 in any appropriate layout manner such as a nine-square grid and a ring shape, and the layout manner may be default or set by the streamer user. In some embodiments, the terminal device 120 may prominently present, in the area 210, a user who currently has the most points or a user who is currently speaking. As an example, referring to FIG. 2, if the User H has the most points, or the User H is currently speaking, the terminal device 120 may prominently present in the area 210 the user avatar corresponding to the User H.

The area 220 may include an input box 220 through which the terminal device 120 may receive comment information for the live streaming and present the received comment information in the area 220. The area 220 may include a control 224, and the terminal device 120 may give a certain number of virtual resources to a designated user in the live streaming in response to receiving the triggering of the control 224, where the designated user may be any user of the target user and the at least one invited user. The area 220 may include interactive information associated with the live streaming. The interactive information may include, for example, prompt information about a user of a designated type watching the live streaming (e.g., a VIP user joining the live streaming room), comment information on the live streaming from a viewing user watching the live streaming (e.g., comment information from User 1 to User 5 shown in the figure), prompt information corresponding to a virtual resource giving behavior of the viewing user to the streamer user/invited user (e.g., a viewing User A gives XXX to the User A), and like information for the live streaming from the viewing user (e.g., a viewing User B gives likes for XXX times), etc.

For example, the terminal device 120 may determine that a presentation request to present a three-dimensional object in the interface is received in response to receiving a request to give a gift to the streamer user/a certain invited user. For example, the terminal device 120 may determine that the request to give the gift to the user is received in response to receiving a selection of a certain user from the streamer user/invited user and receiving the triggering of the control 224. It may be understood that the terminal device 120 may also receive the request to give the gift to the certain user in any other appropriate manner.

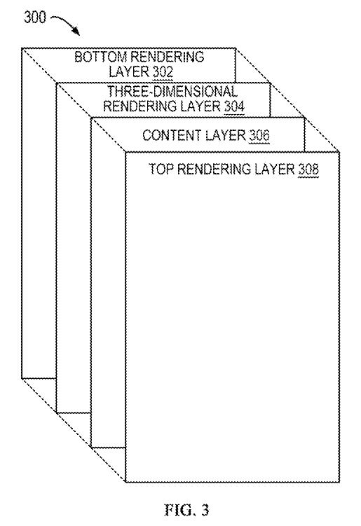

The terminal device 120 may add a three-dimensional rendering layer corresponding to a three-dimensional space to the interface (i.e., the live streaming interface) in response to receiving the presentation request to present the three-dimensional object in the interface. FIG. 3 shows an example 300 of an interface according to some embodiments of the present disclosure. Traditionally, the interface only includes one content layer 306 corresponding to two-dimensional controls, and the terminal device 120 may directly present various content on the content layer 306. The content layer 306 may also be directly regarded as the interface of the application. In the example 300, the terminal device 120 may add a three-dimensional rendering layer 304 to the live streaming interface. The content layer 306 may be superimposed on the three-dimensional rendering layer 304.

The terminal device 120 may generate, in the three-dimensional space, a three-dimensional visual element corresponding to a two-dimensional visual element in the interface, where a three-dimensional position of the three-dimensional visual element in the three-dimensional space corresponds to a two-dimensional position of the two-dimensional visual element in the interface. The two-dimensional visual element may be a visual element of a predetermined type in the interface, which for example, may include an avatar of the streamer user/invited user in the interface. Alternatively, and/or additionally, the two-dimensional visual element may include other controls represented in a two-dimensional format in the interface.

In some embodiments, the terminal device 120 may further update, in the three-dimensional space, a plurality of three-dimensional visual elements respectively corresponding to a plurality of two-dimensional visual elements in response to determining that the number of the plurality of invited users changes. For example, if the live streaming initially includes one streamer user and three invited users, the terminal device 120 may generate four three-dimensional visual elements in the three-dimensional space. If two additional invited users join the live streaming later, the terminal device 120 may update the plurality of three-dimensional visual elements, and the updated plurality of three-dimensional visual elements includes six three-dimensional visual elements.

In some embodiments, the terminal device 120 may further update, in the three-dimensional space, the plurality of three-dimensional visual elements respectively corresponding to the plurality of two-dimensional visual elements in response to determining that the plurality of invited users changes. For example, if the live streaming initially includes one streamer user and three invited users (e.g., invited User A to User C), the terminal device 120 may generate four three-dimensional visual elements in the three-dimensional space corresponding to the streamer user and the three invited users. If subsequently the invited User A exits the live streaming and an invited User D joins the live streaming, the terminal device 120 may update the plurality of three-dimensional visual elements, and the updated plurality of three-dimensional visual elements includes four three-dimensional visual elements corresponding to one streamer user and three invited users (e.g., invited User B to User D).

In this way, the plurality of three-dimensional visual elements in the three-dimensional space can be updated in real time, the latest status of the users involved in the live streaming can be reflected, and the visual experience of the viewing user watching the live streaming can be improved.

The terminal device 120 may further add the three-dimensional object specified by the presentation request to the three-dimensional space. The specified three-dimensional object may be a certain three-dimensional object determined by the terminal device 120 from a plurality of three-dimensional objects in real time based on the presentation request. It may be a default three-dimensional object, a historical three-dimensional object added by the terminal device 120 last time, or the like.

In some embodiments, the terminal device 120 may present, in the interface, a plurality of marks respectively corresponding to a plurality of candidate three-dimensional objects in response to receiving the presentation request. The terminal device 120 may determine, in response to receiving a selection of any mark among the plurality of marks, a candidate three-dimensional object corresponding to that mark as the three-dimensional object. Taking a scenario where each three-dimensional object corresponds to one gift in the live streaming as an example, the terminal device 120 may determine that the presentation request to present the three-dimensional object in the interface is received in response to receiving the request to give the gift to the streamer user/a certain invited user.

The terminal device 120 may then present a selection interface of gifts and present in the selection interface a plurality of marks corresponding to a plurality of gifts. The terminal device 120 may, in response to receiving a selection of a certain mark, determine a gift corresponding to the selected mark as the three-dimensional object specified by the presentation request. It may be understood that since the gift-giving is directed towards a certain user, the presentation request is associated with the user, and the three-dimensional object is also associated with the user.

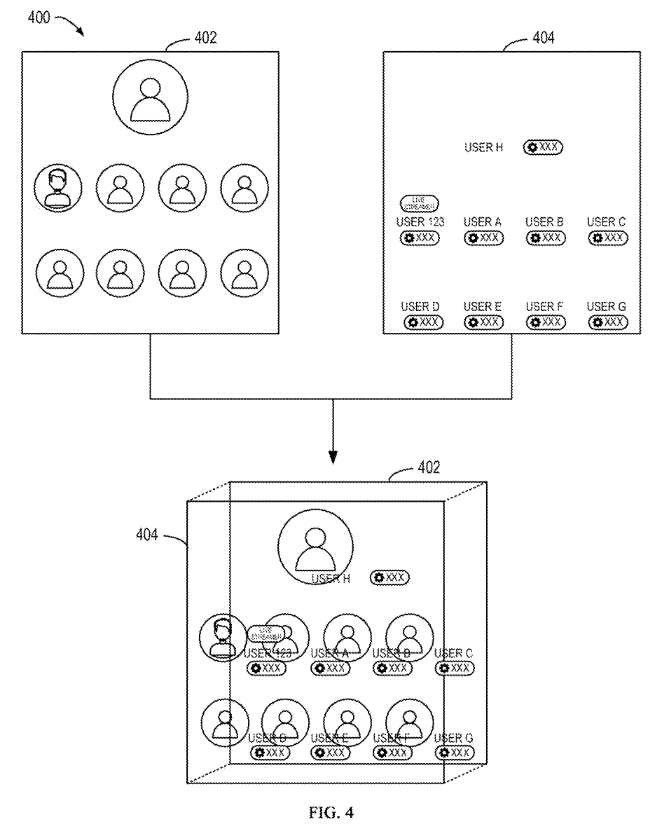

The terminal device 120 may project the three-dimensional visual element and the three-dimensional object to the three-dimensional rendering layer to present the interface. The terminal device 120 may present in the interface the visual element and the three-dimensional object in any appropriate manner. Reference is made to FIG. 4, which shows an example 400 of presenting a three-dimensional object according to some embodiments of the present disclosure. For example, the terminal device 120 may project the user avatars in the example interface 200 in FIG. 2 to the three-dimensional rendering layer to obtain the example 402 in the example 400. The example 402 shows an example of the three-dimensional rendering layer including a plurality of three-dimensional user avatars.

In some embodiments, in the process of presenting the interface, the three-dimensional visual element and the three-dimensional object may be projected onto the three-dimensional rendering layer, to present the two-dimensional visual element and the three-dimensional object in the interface. Alternatively, and/or additionally, in the process of presenting the interface, the three-dimensional visual element and the three-dimensional object may be projected onto the three-dimensional rendering layer, to present the three-dimensional visual element and the three-dimensional object in the interface. In this case, the three-dimensional visual element is projected onto the three-dimensional rendering layer, and the three-dimensional position of the three-dimensional visual element in the three-dimensional space corresponds to the two-dimensional position of the two-dimensional visual element in the interface. Specifically, since the three-dimensional object and the three-dimensional visual element in the three-dimensional space are represented by three-dimensional coordinates, there may be an occlusion relationship in the direction of the depth axis (e.g., the z-axis). If the three-dimensional object is located behind the three-dimensional visual element, the two-dimensional visual element and the three-dimensional object are presented in the interface. If the three-dimensional object or a part of the three-dimensional object is located in the front of the three-dimensional visual element, the three-dimensional visual element (part of the three-dimensional visual element may be occluded) and the three-dimensional object are presented in the interface.

In some embodiments, the terminal device 120 may further hide in the interface the two-dimensional visual element in response to receiving the presentation request. For example, the terminal device 120 may hide the user avatar in the interface. The example 404 shows an example of the interface in which the user avatar has been hidden. As mentioned above, the interface may be superimposed on the three-dimensional rendering layer, that is, the example 404 may be superimposed on the example 402. In this way, by hiding the two-dimensional visual element in the interface, redundant presentation of both the two-dimensional visual element and the three-dimensional visual element can be avoided, and clutter of page elements can be avoided.

Regarding the specific manner of presenting the three-dimensional object, in some embodiments, the terminal device 120 may obtain a motion trajectory of the three-dimensional object and move the three-dimensional object in the three-dimensional space according to the motion trajectory. The motion trajectory of the three-dimensional object may be set by default. That is, the terminal device 120 may each time dynamically present the three-dimensional object in the interface with a corresponding default motion trajectory based on the three-dimensional object. Each three-dimensional object may also have a plurality of candidate motion trajectories, and the terminal device 120 may each time determine (either sequentially or randomly) one motion trajectory from the plurality of candidate motion trajectories, and dynamically present the three-dimensional object in the interface according to the motion trajectory.

In some embodiments, the terminal device 120 may further generate the motion trajectory of the three-dimensional object in real time. The motion trajectory may be any appropriate trajectory such as a straight line, a curve, and a spiral. The motion trajectory can enhance the visual effect of the three-dimensional object. In this case, the terminal device 120 may determine a plurality of trajectory points (the trajectory point refers to a point used to determine the motion trajectory). The plurality of trajectory points at least includes a start point and an end point of the motion trajectory. The plurality of trajectory points may further include any other appropriate points, such as an inflection point of the motion trajectory, the lowest point of the motion trajectory, the highest point of the motion trajectory, and the like. The terminal device 120 may generate the motion trajectory based on the plurality of trajectory points.

As mentioned above, the interface may include a plurality of two-dimensional visual elements, and each three-dimensional visual element corresponds to the two-dimensional visual element in the interface. Therefore, the three-dimensional rendering layer may include a plurality of three-dimensional visual elements. For example, the terminal device 120 may determine a target three-dimensional position of a target three-dimensional visual element corresponding to a target two-dimensional visual element in the three-dimensional space in response to receiving a selection request for the target two-dimensional visual element from the plurality of two-dimensional visual elements in the interface. For example, the terminal device 120 may determine the trajectory point of the motion trajectory based on the target three-dimensional position. For example, the terminal device 120 may determine the end point of the motion trajectory based on the target three-dimensional position.

Taking the two-dimensional visual element being a user avatar as an example, the three-dimensional rendering layer may include a plurality of three-dimensional user avatars. For example, the terminal device 120 may, in response to receiving the presentation request, determine that a selection request for the user avatar corresponding to the user (i.e., the user receiving the gift) corresponding to the presentation request is received. The terminal device 120 may determine the user avatar as a target user avatar, and may determine the trajectory point of the motion trajectory based on a target three-dimensional user avatar of the target user avatar in the three-dimensional rendering layer.

It may be understood that the terminal device 120 may determine the trajectory point in any appropriate manner. It may also be understood that in some embodiments, the terminal device 120 may also determine the motion trajectory in any other appropriate manner. By way of example only, the terminal device 120 may determine the motion trajectory based on a predetermined algorithm, formula, or by using a trained machine learning model. For example, a Bezier curve may be generated based on a plurality of predetermined trajectory points, and then a smooth motion trajectory may be generated.

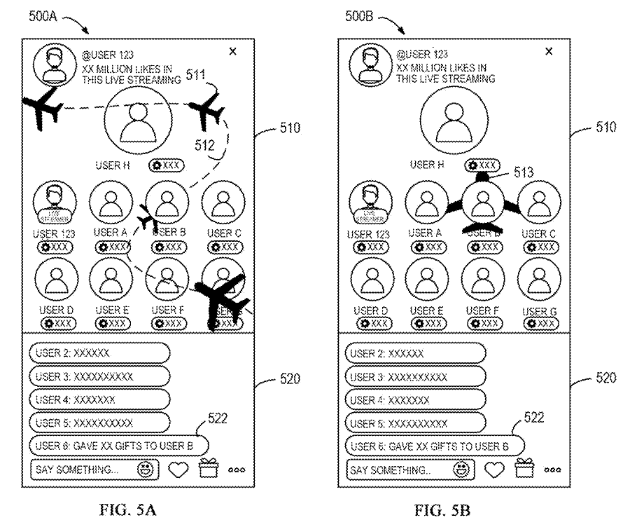

In some embodiments, the terminal device 120 may further present a media item associated with the three-dimensional object in response to determining that the three-dimensional object has reached an end point of the motion trajectory, in other words, the media item may be presented when the motion of the three-dimensional object ends. The media item may include any appropriate type of content such as an audio, a video, an image, an icon, and a text. Reference is made to FIGS. 5A to 5C, which show example interfaces 500A to 500C according to some embodiments of the present disclosure. The example interfaces 500A to 500C may correspond to the example interface 200 in FIG. 2, an area 510 may correspond to the area 210, and an area 520 may correspond to the area 220. Taking the three-dimensional visual element corresponding to the User B as the target three-dimensional visual element (i.e., the presentation request is associated with the User B) as an example, the terminal device 120 may present a prompt message 522 in the area 520. The prompt message may be used to indicate which user the presentation request is associated with, that is, to indicate which user is the recipient of the gift.

For example, the terminal device 120 may determine the trajectory point based on the target three-dimensional position of the three-dimensional visual element corresponding to the User B in the three-dimensional space. For example, the terminal device 120 may determine a motion trajectory 512 based on the trajectory point. The terminal device 120 may move a three-dimensional object 511 according to the motion trajectory 512. It should be noted that because the motion trajectory is the motion trajectory in the three-dimensional space, in the example interface 500A, the size of the three-dimensional object 511 may be affected by the motion trajectory. That is, from the user's perspective, the size of the three-dimensional object 511 seen by the user may change during the moving process, and the closer the three-dimensional object 511 is to the user, the larger the size of the three-dimensional object 511 is.

The terminal device 120 may present the example interface 500B in response to the three-dimensional object being moved to the end point of the trajectory. The terminal device 120 may present in the example interface 500B the media item associated with the three-dimensional object 511. The media item, for example, may indicate presentation of an element 513 at the three-dimensional visual element corresponding to the User B. In this way, by presenting the media item, it may be indicated which user in the live streaming the presentation request corresponds to, thereby highlighting the gift-giving effect in the live streaming. It should be understood that compared to presenting a complex visual effect with the three-dimensional object, playing the media item in animation only occupies fewer computing resources. In this way, resource overhead can be reduced while ensuring the visual effect.

In some embodiments, the terminal device 120 may also determine a motion trajectory 515 shown in the example interface 500C, and the motion trajectory 515 may indicate that the three-dimensional object may move around the target three-dimensional visual element (i.e., the three-dimensional visual element corresponding to the User B). Such a motion trajectory may also highlight the target three-dimensional visual element, indicating which user in the live streaming the presentation request corresponds to.

In some embodiments, the terminal device 120 may also delete the three-dimensional rendering layer and present the two-dimensional visual element in the interface in response to determining that the three-dimensional object has been moved according to the motion trajectory (i.e., the three-dimensional object has been moved to the end point or the media item associated with the three-dimensional object has been presented). The terminal device 120 may directly delete the three-dimensional rendering layer in response to determining that the three-dimensional object has been moved according to the motion trajectory. This can release resources in time, and reduce the resource consumption required for presenting the three-dimensional rendering layer for a long time.

The terminal device 120 may maintain presentation of the three-dimensional rendering layer in response to determining that the three-dimensional object has been moved according to the motion trajectory, and delete the three-dimensional rendering layer in response to a presentation duration reaching a duration threshold. In this case, if the terminal device 120 receives multiple presentation requests within a certain period of time, it may avoid repeatedly adding the three-dimensional rendering layer, and instead add it only once, thereby reducing the resource consumption required for adding the three-dimensional rendering layer. In the case of the three-dimensional gift described above, a list of three-dimensional gifts may be established, the three-dimensional rendering layer may be kept when the list is not empty, and the three-dimensional rendering layer may be deleted when the list is empty for a certain length of time.

In some embodiments, to enrich the content of the interface, the terminal device 120 may further obtain a visual resource associated with the three-dimensional object, and may present the visual resource in a resource rendering layer different from the three-dimensional rendering layer in the interface. The visual resource may include at least one visual resource, and the resource rendering layer is located above or below the three-dimensional rendering layer.

Continuing to refer to FIG. 3, the terminal device 120 may further add a bottom rendering layer 302 and a top rendering layer 308. The bottom rendering layer 302 may be a resource rendering layer located below the three-dimensional rendering layer 304, and the top rendering layer 308 may be a resource rendering layer located above the three-dimensional rendering layer 304. It may be understood that the visual resource presented in the bottom rendering layer 302 may be regarded as the background of the three-dimensional visual element and the three-dimensional object, and the visual resource presented in the top rendering layer 308 may always be the foreground of the three-dimensional visual element and the three-dimensional object. For example, mountains may be presented in the background, and clouds may be presented in the foreground. In this way, different content can be displayed in multiple layers, the three-dimensional visual effect of the interface content can be improved, and the visual experience of the user watching the live streaming and interacting in the live streaming can be improved.

In summary, according to the embodiments of the present disclosure, a three-dimensional effect may be displayed on a two-dimensional screen. This can enrich the interface content of the live streaming interface, enrich the visual effect of the live streaming interface, and improve the visual experience of the user watching the live streaming and interacting in the live streaming.

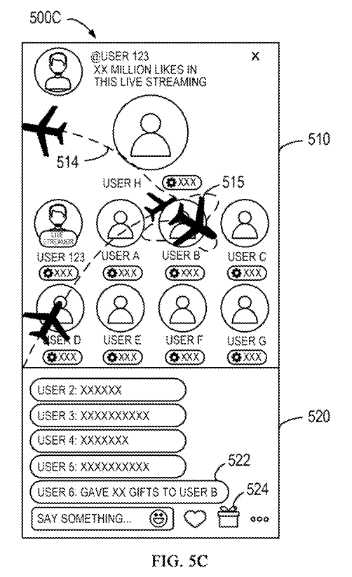

FIG. 6 shows a flowchart of a method 600 for presenting a three-dimensional object in an interface according to some embodiments of the present disclosure. The method 600 may be implemented at the terminal device 120. The method 600 will be described below with reference to FIG. 1.

At block 610, the terminal device 120 adds a three-dimensional rendering layer to the interface in response to receiving a presentation request to present the three-dimensional object in the interface, the three-dimensional rendering layer corresponding to a three-dimensional space.

At block 620, the terminal device 120 generates, in the three-dimensional space, a three-dimensional visual element corresponding to a two-dimensional visual element in the interface, a three-dimensional position of the three-dimensional visual element in the three-dimensional space corresponding to a two-dimensional position of the two-dimensional visual element in the interface.

At block 630, the terminal device 120 adds the three-dimensional object specified by the presentation request to the three-dimensional space.

At block 640, the terminal device 120 projects the three-dimensional visual element and the three-dimensional object to the three-dimensional rendering layer.

In some embodiments, presenting the three-dimensional object in the interface includes: obtaining a motion trajectory of the three-dimensional object; and moving the three-dimensional object in the three-dimensional space according to the motion trajectory.

In some embodiments, the two-dimensional visual element includes a plurality of two-dimensional visual elements, and obtaining the motion trajectory includes: determining a target three-dimensional position of a target three-dimensional visual element corresponding to a target two-dimensional visual element in the three-dimensional space in response to receiving a selection request for the target two-dimensional visual element from the plurality of two-dimensional visual elements; and setting an end point of the motion trajectory based on the target three-dimensional position.

In some embodiments, the method 600 further includes: presenting a media item associated with the three-dimensional object in response to determining that the three-dimensional object has reached the end point of the motion trajectory.

In some embodiments, the method 600 further includes: hiding in the interface the two-dimensional visual element in response to receiving the presentation request; and deleting the three-dimensional rendering layer and presenting in the interface the two-dimensional visual element in response to determining that the three-dimensional object has been moved according to the motion trajectory.

In some embodiments, the interface is a live streaming interface, the plurality of two-dimensional visual elements respectively corresponds to a plurality of invited users in the live streaming interface, and the presentation request is a request to give a gift to an invited user from the plurality of invited users.

In some embodiments, the method 600 further includes: updating, in the three-dimensional space, a plurality of three-dimensional visual elements respectively corresponding to the plurality of two-dimensional visual elements in response to determining that a number of the plurality of invited users changes.

In some embodiments, the method 600 further includes: obtaining a visual resource associated with the three-dimensional object; and presenting the visual resource in a resource rendering layer different from the three-dimensional rendering layer in the interface.

In some embodiments, the visual resource includes at least one visual resource, and the resource rendering layer is located above or below the three-dimensional rendering layer.

In some embodiments, the method 600 further includes: presenting a plurality of marks respectively corresponding to a plurality of candidate three-dimensional objects in response to receiving the presentation request; and determining, in response to receiving a selection of a mark from the plurality of marks, a candidate three-dimensional object corresponding to the mark as the three-dimensional object.

In some embodiments, projecting the three-dimensional visual element and the three-dimensional object to the three-dimensional rendering layer includes at least one of: projecting the three-dimensional visual element and the three-dimensional object to the three-dimensional rendering layer to present the two-dimensional visual element and the three-dimensional object in the interface; or projecting the three-dimensional visual element and the three-dimensional object to the three-dimensional rendering layer to present the three-dimensional visual element and the three-dimensional object in the interface.

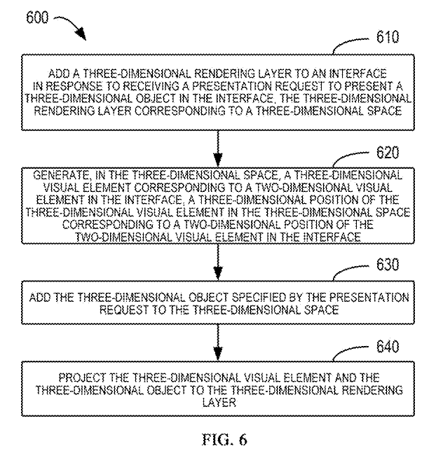

The embodiments of the present disclosure further provide a corresponding apparatus for implementing the above methods or processes. FIG. 7 shows a schematic structural block diagram of an apparatus 700 for presenting a three-dimensional object in an interface according to some embodiments of the present disclosure. The apparatus 700, for example, may be implemented or included in the terminal device 120. Each module/component in the apparatus 700 may be implemented by hardware, software, firmware, or any combination thereof.

As shown in the figure, the apparatus 700 includes a receiving module 710 configured to add, in response to receiving a presentation request to present the three-dimensional object in the interface, a three-dimensional rendering layer to the interface, the three-dimensional rendering layer corresponding to a three-dimensional space. The apparatus 700 further includes a generation module 720 configured to generate, in the three-dimensional space, a three-dimensional visual element corresponding to a two-dimensional visual element in the interface, a three-dimensional position of the three-dimensional visual element in the three-dimensional space corresponding to a two-dimensional position of the two-dimensional visual element in the interface. The apparatus 700 further includes an addition module 730 configured to add the three-dimensional object specified by the presentation request to the three-dimensional space. The apparatus 700 further includes a presentation module 740 configured to project the three-dimensional visual element and the three-dimensional object to the three-dimensional rendering layer.

In some embodiments, the presentation module 740 is further configured to: obtain a motion trajectory of the three-dimensional object; and move the three-dimensional object in the three-dimensional space according to the motion trajectory.

In some embodiments, the two-dimensional visual element includes a plurality of two-dimensional visual elements, and the presentation module 740 is further configured to: determine a target three-dimensional position of a target three-dimensional visual element corresponding to a target two-dimensional visual element in the three-dimensional space in response to receiving a selection request for the target two-dimensional visual element from the plurality of two-dimensional visual elements; and set an end point of the motion trajectory based on the target three-dimensional position.

In some embodiments, the apparatus 700 further includes a media item presentation module configured to present a media item associated with the three-dimensional object in response to determining that the three-dimensional object has reached the end point of the motion trajectory.

In some embodiments, the apparatus 700 further includes a hiding module configured to hide in the interface the two-dimensional visual element in response to receiving the presentation request; and a deletion module configured to delete the three-dimensional rendering layer and present in the interface the two-dimensional visual element in response to determining that the three-dimensional object has been moved according to the motion trajectory.

In some embodiments, the interface is a live streaming interface, the plurality of two-dimensional visual elements respectively corresponds to a plurality of invited users in the live streaming interface, and the presentation request is a request to give a gift to an invited user from the plurality of invited users.

In some embodiments, the apparatus 700 further includes an updating module configured to update, in the three-dimensional space, a plurality of three-dimensional visual elements respectively corresponding to the plurality of two-dimensional visual elements in response to determining that a number of the plurality of invited users changes.

In some embodiments, the apparatus 700 further includes a resource obtaining module configured to obtain a visual resource associated with the three-dimensional object; and a resource presentation module configured to present the visual resource in a resource rendering layer different from the three-dimensional rendering layer in the interface.

In some embodiments, the visual resource includes at least one visual resource, and the resource rendering layer is located above or below the three-dimensional rendering layer.

In some embodiments, the apparatus 700 further includes a mark presentation module configured to present a plurality of marks respectively corresponding to a plurality of candidate three-dimensional objects in response to receiving the presentation request; and an object determination module configured to determine, in response to receiving a selection of a mark from the plurality of marks, a candidate three-dimensional object corresponding to the mark as the three-dimensional object.

In some embodiments, the presentation module 740 is further configured to: project the three-dimensional visual element and the three-dimensional object to the three-dimensional rendering layer to present the two-dimensional visual element and the three-dimensional object in the interface; or project the three-dimensional visual element and the three-dimensional object to the three-dimensional rendering layer to present the three-dimensional visual element and the three-dimensional object in the interface.

The units and/or modules included in the apparatus 700 may be implemented in various ways, including software, hardware, firmware, or any combination thereof. In some embodiments, one or more units and/or modules may be implemented using software and/or firmware, for example machine executable instructions stored on a storage medium. In addition to machine executable instructions or as an alternative, some or all units and/or modules in the apparatus 700 may be implemented at least partially by one or more hardware logic components. As an example, rather than a limitation, example types of hardware logic components that may be used include field programmable gate array (FPGA), application specific integrated circuit (ASIC), application specific standard (ASSP), system on chip (SOC), complex programmable logic device (CPLD), and so on.

It should be understood that one or more steps in the above methods may be performed by appropriate electronic device or combination of electronic devices. Such electronic device or combination of electronic devices may include, for example, the terminal device 120 and/or the server 130 in FIG. 1.

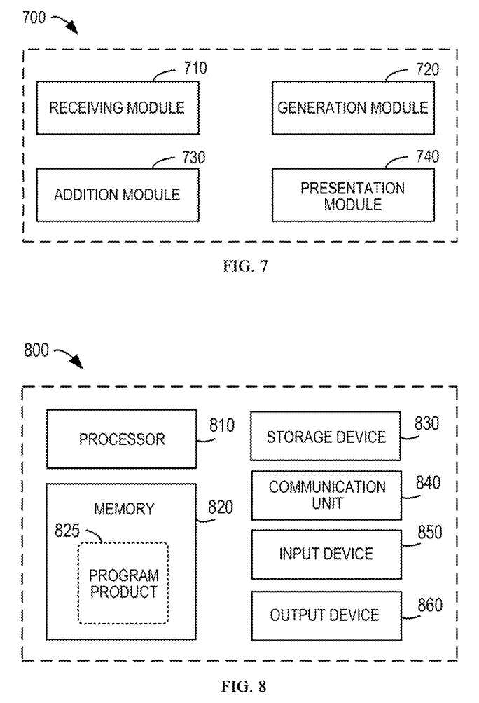

FIG. 8 shows a block diagram of an electronic device 800 in which one or more embodiments of the present disclosure may be implemented. It should be understood that the electronic device 800 shown in FIG. 8 is only illustrative, and should not constitute any limitation on the functions and scope of the embodiments described herein. The electronic device 800 shown in FIG. 8 may include or be implemented as the terminal device 120 in FIG. 1 or the apparatus 700 in FIG. 7.

As shown in FIG. 8, the electronic device 800 is in the form of a general electronic device. The components of the electronic device 800 may include but are not limited to one or more processors or processors 810, a memory 820, a storage device 830, one or more communication units 840, one or more input devices 850, and one or more output devices 860. The processor 810 may be an actual or virtual processor, and may execute various processes based on the programs stored in the memory 820. In a multi-processor system, multiple processors execute computer executable instructions in parallel to improve the parallel processing capability of the electronic device 800.

The electronic device 800 typically includes multiple computer storage medium. Such medium may be any available medium that is accessible by the electronic device 800, including but not limited to volatile and non-volatile medium, and removable and non-removable medium. The memory 820 may be a volatile memory (for example, a register, a cache, a random access memory (RAM)), a non-volatile memory (such as a read-only memory (ROM), an electrically erasable programmable read-only memory (EEPROM), a flash memory), or any combination thereof. The storage device 830 may be any removable or non-removable medium, and may include a machine readable medium such as a flash drive, a disk, or any other medium, which may be used to store information and/or data and may be accessed within the electronic device 800.

The electronic device 800 may further include additional removable/non-removable, volatile/non-volatile memory medium. Although not shown in FIG. 8, a disk driver for reading from or writing to a removable, non-volatile disk (such as a "floppy disk"), and an optical disk driver for reading from or writing to a removable, non-volatile optical disk may be provided. In these cases, each driver may be connected to a bus (not shown) by one or more data medium interfaces. The memory 820 may include a computer program product 825 having one or more program modules configured to perform various methods or acts of the various embodiments of the present disclosure.

The communication unit 840 implements communication with other electronic devices through the communication medium. Additionally, the functions of the components of the electronic device 800 may be implemented by a single computing cluster or multiple computing machines, which may communicate through communication connections. Therefore, the electronic device 800 may use a logical connection with one or more other servers, a network personal computer (PC), or another network node to operate in a networked environment.

The input device 850 may be one or more input devices, such as a mouse, a keyboard, a tracking ball, etc. The output device 860 may be one or more output devices, such as a display, a speaker, a printer, etc. The electronic device 800 may also communicate with one or more external devices (not shown) such as a storage device and a display device, with one or more devices enabling the user to interact with the electronic device 800, or with any devices (for example, a network card, a modem, etc.) enabling the electronic device 800 to communicate with one or more other electronic devices through the communication unit 840 as needed. Such communication may be performed via input/output (I/O) interfaces (not shown).

According to an example implementation of the present disclosure, there is provided a computer-readable storage medium having computer executable instructions stored thereon, where the computer executable instructions are executed by a processor to implement the method described above. According to an example implementation of the present disclosure, there is further provided a computer program product tangibly stored on a non-transitory computer-readable medium and including computer executable instructions, where the computer executable instructions are executed by a processor to implement the method described above.

Various aspects of the present disclosure are described herein with reference to the flowcharts and/or block diagrams of the method, apparatus, device, and computer program product implemented according to the present disclosure. It should be understood that each block of the flowcharts and/or block diagrams, and combinations of blocks in the flowcharts and/or block diagrams may be implemented by computer-readable program instructions.

These computer-readable program instructions may be provided to a processor of a general-purpose computer, a special-purpose computer, or other programmable data processing apparatus to produce a machine, such that when the instructions are executed by the processor of the computer or other programmable data processing apparatus, an apparatus for implementing the functions/actions specified in one or more blocks of the flowcharts and/or block diagrams is produced. These computer-readable program instructions may also be stored in a computer-readable storage medium, and these instructions cause the computer, the programmable data processing apparatus, and/or other devices to work in a specific manner, so that the computer-readable medium storing the instructions includes a manufactured product, which includes instructions for implementing various aspects of the functions/actions specified in one or more blocks of the flowcharts and/or block diagrams.

The computer-readable program instructions may be loaded onto a computer, other programmable data processing apparatus, or other devices, so that a series of operations and steps are performed on the computer, other programmable data processing apparatus, or other devices to produce a computer-implemented process, thereby causing the instructions executed on the computer, other programmable data processing apparatus, or other devices to implement the functions/actions specified in one or more blocks of the flowcharts and/or block diagrams.

The flowcharts and block diagrams in the drawings show the possibly implemented architectures, functions, and operations of the system, method, and computer program product according to multiple implementations of the present disclosure. In this regard, each block in the flowchart or block diagram may represent a module, program segment, or part of an instruction, and the module, program segment, or part of the instruction contains one or more executable instructions for implementing the specified logical functions. In some implementations as updates, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and combinations of the blocks in the block diagrams and/or flowcharts may be implemented by a special-purpose hardware-based system that perform the specified functions or actions, or by a combination of special-purpose hardware and computer instructions.

The implementations of the present disclosure have been described above, and the above description is illustrative, not exhaustive, and is not limited to the disclosed implementations. Without departing from the scope and spirit of the described implementations, many modifications and changes will be apparent to those of ordinary skill in the art. The choice of terms used herein is intended to best explain the principles of the implementations, the practical applications, or improvements to the technologies in the market, or to enable other ordinary skilled persons in the art to understand the implementations disclosed herein.

What is claimed is:

1. A method for presenting a three-dimensional object in an interface, comprising:
adding, in response to receiving a presentation request to present the three-dimensional object in the interface, a three-dimensional rendering layer to the interface, the three-dimensional rendering layer corresponding to a three-dimensional space;
generating, in the three-dimensional space, a three-dimensional visual element corresponding to a two-dimensional visual element in the interface, a three-dimensional position of the three-dimensional visual element in the three-dimensional space corresponding to a two-dimensional position of the two-dimensional visual element in the interface;
adding the three-dimensional object specified by the presentation request to the three-dimensional space; and
projecting the three-dimensional visual element and the three-dimensional object to the three-dimensional rendering layer.

2. The method of claim 1, wherein presenting the three-dimensional object in the interface comprises:
obtaining a motion trajectory of the three-dimensional object; and
moving the three-dimensional object in the three-dimensional space according to the motion trajectory.

3. The method of claim 2, wherein the two-dimensional visual element comprises a plurality of two-dimensional visual elements, and obtaining the motion trajectory comprises:
determining a first three-dimensional position of a first three-dimensional visual element corresponding to a first two-dimensional visual element in the three-dimensional space in response to receiving a selection request for the first two-dimensional visual element from the plurality of two-dimensional visual elements; and
setting an end point of the motion trajectory based on the first three-dimensional position.

4. The method of claim 3, further comprising:
presenting a media item associated with the three-dimensional object in response to determining that the three-dimensional object has reached the end point of the motion trajectory.

5. The method of claim 2, further comprising:
hiding in the interface the two-dimensional visual element in response to receiving the presentation request; and
deleting the three-dimensional rendering layer and presenting in the interface the two-dimensional visual element in response to determining that the three-dimensional object has been moved according to the motion trajectory.

6. The method of claim 3, wherein the interface is a live streaming interface, the plurality of two-dimensional visual elements respectively corresponds to a plurality of invited users in the live streaming interface, and the presentation request is a request to give a gift to an invited user from the plurality of invited users.

7. The method of claim 6, further comprising:
updating, in the three-dimensional space, a plurality of three-dimensional visual elements respectively corresponding to the plurality of two-dimensional visual elements in response to determining that a number of the plurality of invited users changes.

8. The method of claim 1, further comprising:
obtaining a visual resource associated with the three-dimensional object; and
presenting the visual resource in a resource rendering layer different from the three-dimensional rendering layer in the interface.

9. The method of claim 8, wherein the visual resource comprises at least one visual resource, and the resource rendering layer is located above or below the three-dimensional rendering layer.

10. The method of claim 1, further comprising:
presenting a plurality of marks respectively corresponding to a plurality of candidate three-dimensional objects in response to receiving the presentation request; and
determining, in response to receiving a selection of a mark from the plurality of marks, a candidate three-dimensional object corresponding to the mark as the three-dimensional object.

11. The method of claim 1, wherein projecting the three-dimensional visual element and the three-dimensional object to the three-dimensional rendering layer comprises at least one of:
projecting the three-dimensional visual element and the three-dimensional object to the three-dimensional rendering layer to present the two-dimensional visual element and the three-dimensional object in the interface; or
projecting the three-dimensional visual element and the three-dimensional object to the three-dimensional rendering layer to present the three-dimensional visual element and the three-dimensional object in the interface.

12. An electronic device, comprising:
at least one processor; and
at least one memory, the at least one memory being coupled to the at least one processor and storing instructions executable by the at least one processor, the instructions, when executed by the at least one processor, causing the electronic device to perform operations comprising:
adding, in response to receiving a presentation request to present the three-dimensional object in the interface, a three-dimensional rendering layer to the interface, the three-dimensional rendering layer corresponding to a three-dimensional space;
generating, in the three-dimensional space, a three-dimensional visual element corresponding to a two-dimensional visual element in the interface, a three-dimensional position of the three-dimensional visual element in the three-dimensional space corresponding to a two-dimensional position of the two-dimensional visual element in the interface;
adding the three-dimensional object specified by the presentation request to the three-dimensional space; and
projecting the three-dimensional visual element and the three-dimensional object to the three-dimensional rendering layer.

13. The electronic device of claim 12, wherein presenting the three-dimensional object in the interface comprises:
obtaining a motion trajectory of the three-dimensional object; and
moving the three-dimensional object in the three-dimensional space according to the motion trajectory.

14. The electronic device of claim 13, wherein the two-dimensional visual element comprises a plurality of two-dimensional visual elements, and obtaining the motion trajectory comprises:
determining a first three-dimensional position of a first three-dimensional visual element corresponding to a first two-dimensional visual element in the three-dimensional space in response to receiving a selection request for the first two-dimensional visual element from the plurality of two-dimensional visual elements; and
setting an end point of the motion trajectory based on the first three-dimensional position.

15. The electronic device of claim 14, wherein the operations further comprise:
presenting a media item associated with the three-dimensional object in response to determining that the three-dimensional object has reached the end point of the motion trajectory.

16. The electronic device of claim 13, wherein the operations further comprise:
hiding in the interface the two-dimensional visual element in response to receiving the presentation request; and
deleting the three-dimensional rendering layer and presenting in the interface the two-dimensional visual element in response to determining that the three-dimensional object has been moved according to the motion trajectory.

17. The electronic device of claim 14, wherein the interface is a live streaming interface, the plurality of two-dimensional visual elements respectively corresponds to a plurality of invited users in the live streaming interface, and the presentation request is a request to give a gift to an invited user from the plurality of invited users.

18. The electronic device of claim 17, wherein the operations further comprise:
updating, in the three-dimensional space, a plurality of three-dimensional visual elements respectively corresponding to the plurality of two-dimensional visual elements in response to determining that a number of the plurality of invited users changes.

19. The electronic device of claim 12, wherein the operations further comprise:
obtaining a visual resource associated with the three-dimensional object; and
presenting the visual resource in a resource rendering layer different from the three-dimensional rendering layer in the interface.

20. A non-transitory computer-readable storage medium having computer executable instructions stored thereon, the computer executable instructions being executable by a processor to perform operations comprising: adding, in response to receiving a presentation request to present the three-dimensional object in the interface, a three-dimensional rendering layer to the interface, the three-dimensional rendering layer corresponding to a three-dimensional space;
generating, in the three-dimensional space, a three-dimensional visual element corresponding to a two-dimensional visual element in the interface, a three-dimensional position of the three-dimensional visual element in the three-dimensional space corresponding to a two-dimensional position of the two-dimensional visual element in the interface;
adding the three-dimensional object specified by the presentation request to the three-dimensional space; and
projecting the three-dimensional visual element and the three-dimensional object to the three-dimensional rendering layer.
